(19) United States
(12) Patent Application Publication
(10) Pub. No.: US 2025/0018722 A1
(43) Pub. Date: Jan. 16, 2025

(54) INK CARTRIDGE

(71) Applicant: Roland DG Corporation, Hamamatsu-shi (JP)

(72) Inventors: Satoshi HIRAIDE, Hamamatsu-shi (JP); Yuki TOMITA, Hamamatsu-shi (JP)

(21) Appl. No.: 18/899,934

(22) Filed: Sep. 27, 2024

Related U.S. Application Data
(63) Continuation of application No. PCT/JP2022/016661, filed on Mar. 31, 2022.

(51) Int. Cl. B41J 2/175

(52) U.S. Cl. CPC B41J 2/17513; B41J 2002/17516

(57) ABSTRACT

An ink cartridge includes a box-shaped case main body including side walls and an opened upper portion, a plate-shaped cover attachably/detachably covering an opening of the case main body and including cover side walls on long sides, inserted into insides of main body side walls on long sides of the case main body in a mounted state, and a replaceable ink bag. The cover includes, on the cover side walls on the two long sides, engagement claws protruding toward the main body side walls facing in the mounted state. The case main body includes, on the main body side walls, engagement holes engageable with the engagement claws, and slide portions including inclined surfaces extending in a long-side direction and inclined upward, near the engagement holes on inside surfaces of the main body side walls, to slide and guide the engagement claws during attachment/detachment of the cover.

### CROSS REFERENCE TO RELATED APPLICATIONS

This application is a Continuation Application of PCT Application No. PCT/JP2022/016661 filed on Mar. 31, 2022. The entire contents of this application are hereby incorporated herein by reference.

### BACKGROUND OF THE INVENTION

### 1. Field of the Invention

The present invention relates to ink cartridges to supplying ink to recording heads of inkjet printers.

### 2. Description of the Related Art

An inkjet printer is an apparatus that is capable of performing printing by reciprocating a recording head that receives supply of ink from an ink cartridge, in a width direction of a recording sheet. In the inkjet printer performing a large amount of printing, the ink cartridge is upsized, and the large ink cartridge cannot be mounted on a carriage.

Therefore, a method in which the ink cartridge is detachably mounted on a main body of the ink jet printer, and the ink is supplied from the ink cartridge to the recording head through a tube has been adopted. The ink cartridge includes a case main body and a cover that constitute a container housing an ink bag (pouch). When the ink in the ink bag is used up, the cover of the ink cartridge is opened, a new ink bag is housed in the case main body, and then, an opening of the case main body is closed by the cover.

An open/close structure of such an ink cartridge has been proposed in, for example, JP-B-5586737, which discloses an open/close structure including hooks provided on long sides of the cover and locking units provided on long sides of the case main body. Each of the locking units includes a groove and an elastic locking portion. In the open/close structure, a positioning projection is provided on a short side of the cover, and a positioning hole is provided on a short side of the case main body.

In the ink cartridge including the above-described open/close structure, the cover is assembled to the case main body by inserting the positioning projection of the cover into the positioning hole of the case main body, and turning the cover around the inserted portion. As a result, the hooks of the cover engage with the respective elastic locking portions of the case main body to push and open the elastic locking portions, and the hooks are inserted into the grooves of the case main body. Thus, the cover is assembled to the case main body.

To detach the cover from the case main body, a finger is inserted into an operation hole provided in the cover, the cover is slid in a long-side direction to cause the hooks and the grooves to disengage from each other, and the cover is turned up and separated from the case main body.

The replaceable ink bag housed in the case main body of the ink cartridge includes an ink supply connector (spout), and the connector is fitted into and fixed to a U-shaped fitting groove of an adapter provided on the case main body (for example, see JP-A-2004-025900).

### SUMMARY OF THE INVENTION

In the open/close structure of the ink cartridge proposed in JP-B-5586737, each of the elastic locking portions of the locking units provided on the case main body is an L-shaped cantilever piece. Therefore, the hooks of the cover are easily separated from the elastic locking portions, and the elastic locking portions may be broken by an external force.

When the cover is detached from the case main body, in a state where the cover is slid in the long-side direction and the hooks and the grooves disengage from each other, the cover is in the state of closing the case main body, and no gap is formed between the cover and the case main body. Thus, it is necessary to insert a finger into the operation hole of the cover in order to detach the cover from the case main body, and the operation hole is necessary in the cover.

In a fitting structure in which the ink supply connector of the ink bag is fitted to the adapter of the case main body as disclosed in JP-A-2004-025900, when a user replaces the ink bag, a position of the ink supply connector of the ink bag is not clear, and the ink supply connector may be fitted to the adapter in an incomplete state. In addition, there is a problem that the user cannot clearly recognize completion of fitting of the ink supply connector to the adapter. Furthermore, there is a problem that the ink supply connector is easily separated from the fitting groove of the adapter.

Example embodiments of the present invention provide ink cartridges in each of which a cover can be surely attached to a case main body and can be easily detached from a case main body, and provide ink cartridges in each of which an ink supply connector of an ink bag is accurately positioned and surely fitted to an adapter of a case main body, and completion of fitting of the ink supply connector to the adapter can be clearly recognized by the user.

An ink cartridge according to an example embodiment of the present invention includes a box-shaped case main body including side walls facing each other and an opening, a cover attachably/detachably covering the opening of the case main body and including cover side walls superimposed on main body side walls of the case main body in a mounted state, a replaceable ink bag housed in a space defined by the case main body and the cover, one or more engagement claws on one of the cover side walls and the main body side walls, and protruding toward the other of the main body side walls and the cover side walls facing in the mounted state, one or more engagement holes on the other of the main body side walls and the cover side walls and engageable with the one or more engagement claws, and slide portions including, near the engagement holes, inclined surfaces extending toward ends of the main body side walls or the cover side walls from the engagement holes to slide and guide the engagement claws when the case main body and the cover are detached from each other.

According to an example embodiment of the present invention, the cover is easily and surely attached to the case main body via a one-touch action by being simply pushed down while the engagement claws are aligned with the respective engagement holes of the case main body, and detachment (separation) of the cover from the case main body is surely prevented.

When the cover is slid, the engagement claws of the cover and the engagement holes of the case main body disengage from each other. When the engagement claws are slid along the inclined surfaces of the slide portions, the cover floats from the case main body, and a gap gradually increases therebetween. Therefore, the user can insert a hand into the gap, lift up the cover, and easily detach the cover from the case main body with high workability.

According to example embodiments of the present invention, it is possible to surely attach the cover to the case main body, and to easily detach the cover from the case main body.

In addition, it is possible to accurately position and surely fit the ink supply connector of the ink bag to the fitting groove of the case main body, and to enable the user to clearly recognize completion of fitting of the ink supply connector to the adapter.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a state where a cover of an ink cartridge according to an example embodiment of the present invention is opened.

FIG. 2 is an enlarged detailed view of a portion A in FIG. 1.

FIG. 3 is a diagram as viewed from an arrow B in FIG. 2.

FIG. 4 is a diagram as viewed from an arrow C in FIG. 2.

FIGS. 5A to 5C are partial vertical cross-sectional views illustrating a method of attaching the cover of an ink cartridge according to an example embodiment of the present invention in a step order.

FIGS. 6A to 6C are partial side views illustrating a method of detaching the cover of the ink cartridge according to an example embodiment of the present invention in a step order (diagrams of case main body as viewed from inside).

FIG. 7 is a cross-sectional view taken along line D-D in FIG. 6A.

FIG. 8 is a cross-sectional view taken along line E-E in FIG. 6B.

FIG. 9 is a front view illustrating a state before an ink bag is mounted on an ink cartridge according to an example embodiment of the present invention.

FIG. 10 is a partial plan view illustrating the state before the ink bag is mounted on an ink cartridge according to an example embodiment of the present invention.

FIG. 11 is a partial front view illustrating a state where the ink bag is mounted on an ink cartridge according to an example embodiment of the present invention.

FIG. 12 is a front view illustrating a state after the ink bag is mounted on an ink cartridge according to an example embodiment of the present invention.

FIG. 13 is a partial front view illustrating the state after the ink bag is mounted on an ink cartridge according to an example embodiment of the present invention.

FIG. 14 is a partial front view illustrating another form 1 of a structure to mount the ink bag.

FIG. 15 is a front view of an adapter main part illustrating another form 2 of the structure to mount the ink bag.

FIG. 16 is a partial front view illustrating a mounted state of the ink bag in another form 2 of the structure to mount the ink bag.

### DETAILED DESCRIPTION OF THE EXAMPLE EMBODIMENTS

Example embodiments of the present invention are described below with reference to the accompanying drawings.

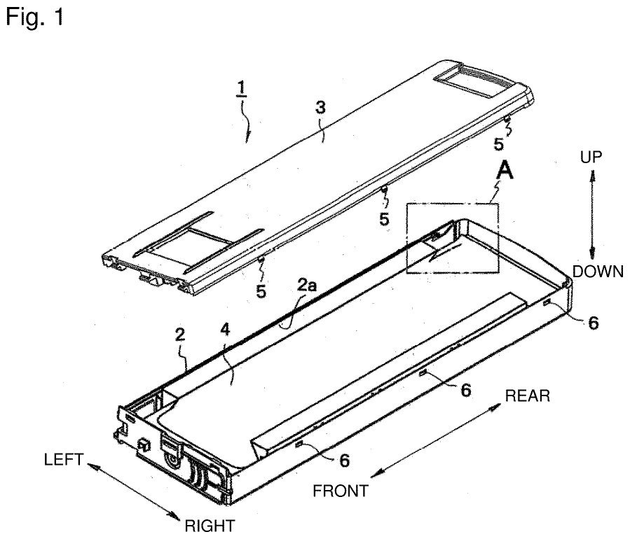

FIG. 1 is a perspective view illustrating a state where a cover of an ink cartridge according to an example embodiment of the present invention is opened. An illustrated ink cartridge 1 includes a rectangular or substantially rectangular box-shaped case main body 2 including an opened surface (upper surface in FIG. 1), a detachable rectangular or substantially rectangular plate-shaped cover 3 covering an opening 2a of the case main body 2, and a replaceable ink bag 4 housed in a space defined by the case main body 2 and the cover 3. Arrow directions in FIG. 1 are defined as a “front-rear” direction, a “right-left” direction, and an “up-down” direction.

On each of right and left edges (long sides or cover side walls) of the cover 3, a plurality (for example, three) of engagement claws (hooks) 5 integrally protrude downward (toward case main body 2) at equal or substantially equal intervals along a longitudinal direction (front-rear direction). In other words, six engagement claws 5 in total are provided on the cover 3, for example. At three positions (three positions corresponding to engagement claws 5 of cover 3, namely, six positions in total, for example) on each of right and left long side walls (main body side walls) 2A of the case main body 2, rectangular or substantially rectangular engagement holes 6 are provided.

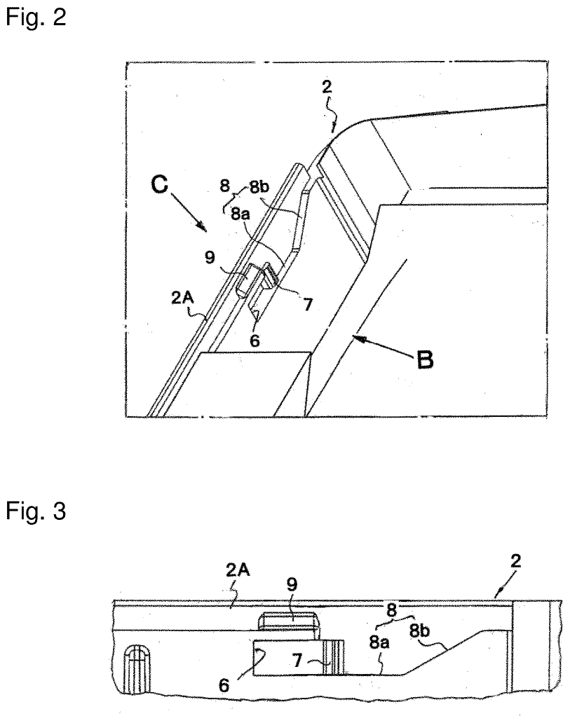

The cover 3 is attached to the case main body 2 by causing the engagement claws 5 to engage with the respective engagement holes 6 of the case main body 2, and the cover 3 is detached from the case main body 2 by causing the engagement claws 5 to disengage from the respective engagement holes 6. In the following, an attachment and detachment structure (attachment/detachment structure) of the cover 3 to the case main body 2 is described with reference to FIG. 2 to FIG. 4.

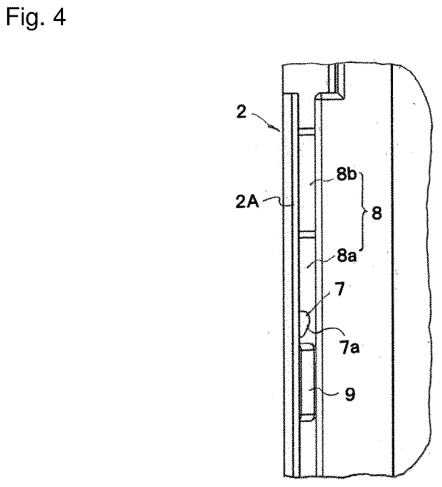

FIG. 2 is an enlarged detailed view of a portion A in FIG. 1, FIG. 3 is a diagram as viewed from an arrow B in FIG. 2, and FIG. 4 is a diagram as viewed from an arrow C in FIG. 2. As illustrated in FIG. 2 and FIG. 3, a guide protrusion 7 is integrally provided along a right edge (one edge in long-side direction (right edge in FIG. 3)) of each engagement hole 6 on inner surfaces of the long side walls (left wall in FIG. 2 and FIG. 3) 2A of the case main body 2 along the front-rear direction. As illustrated in FIG. 4, the guide protrusion 7 includes a tapered surface 7a inclined toward the inside (right side in FIG. 4) of the case main body 2. The tapered surface 7a of the guide protrusion 7 deflects the corresponding engagement claw 5 of the cover 3 in a direction in which the engagement claw 5 of the cover 3 and the corresponding engagement hole 6 of the case main body 2 disengage from each other when the cover 3 is detached from the case main body 2 as described below.

A slide portion 8 extending rearward (rightward in FIG. 3) from a bottom surface of each engagement hole 6 is provided on the inner surfaces of the long side walls 2A of the case main body 2. The slide portion 8 includes a linear straight surface 8a horizontally extending rearward from the corresponding guide protrusion 7, and an inclined surface 8b extending rearward and inclined obliquely upward from the straight surface 8a.

An engagement protrusion 9 horizontally extending in the front-rear direction is integrally provided above each engagement hole 6 on the inner surfaces of the long side walls 2A of the case main body 2. The engagement protrusion 9 guides the corresponding engagement claw 5 of the cover 3 to the engagement hole 6 of the case main body 2 when the cover 3 is attached to the case main body 2 as described below, and inhibits detachment (separation) of the engagement claw 5 of the cover 3 from the engagement hole 6.

Although only the attachment/detachment structure for the cover 3 provided on a portion (portion A in FIG. 1) of the case main body 2 is illustrated and described above, the attachment/detachment structure at each of the other five positions of the case main body 2 (for example, five positions where engagement holes 6 are provided) have the same structure, and therefore, illustration and description of the attachment/detachment structures at the other five portions are omitted.

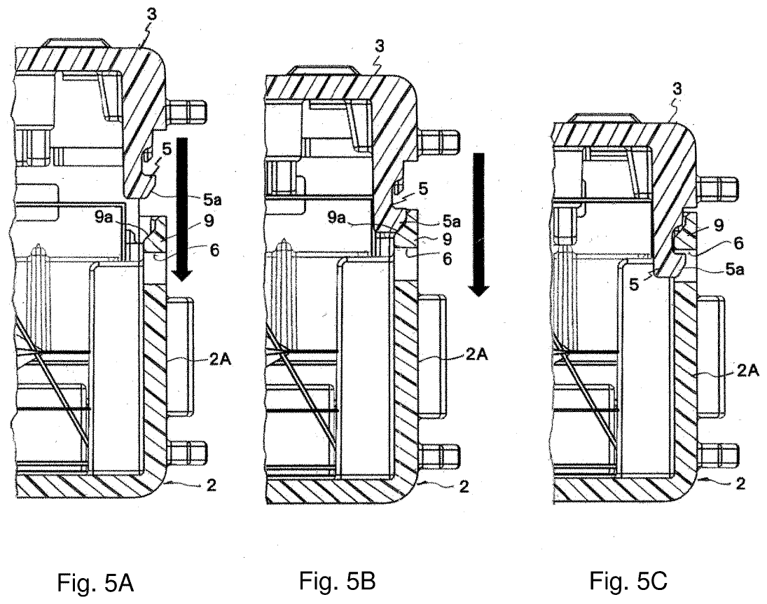

Next, a method of attaching the cover 3 to the case main body 2 in the ink cartridge 1 according to an example embodiment of the present invention is described below with reference to FIGS. 5A to 5C.

FIGS. 5A to 5C are partial vertical cross-sectional views illustrating the method of attaching the cover in a step order. To attach the cover 3 to the case main body 2, the cover 3 is moved downward (in illustrated arrow direction) relative to the case main body 2 so as to cover the case main body 2 from above as illustrated in FIG. 5A. As a result, as illustrated in FIG. 5B, claw portions 5a at front ends (lower ends) of the engagement claws 5 of the cover 3 come into contact with respective tapered surfaces 9a of the engagement protrusions 9 of the case main body 2. When the cover 3 is pushed downward (in illustrated arrow direction) with predetermined force from the state, the engagement claws 5 of the cover 3 are deflected and deformed to the inside (left side in FIG. 5B). Thus, the engagement claws 5 pass through the respective engagement protrusions 9 of the case main body 2 and are moved downward.

When the cover 3 is pushed down until the cover 3 completely covers the case main body 2, and the claw portions 5a of the engagement claws 5 of the cover 3 pass through the respective engagement protrusions 9 and are aligned with the engagement holes 6 of the case main body 2 as illustrated in FIG. 5C, the engagement claws 5 return to original states via an elastic restoring force, and the claw portions 5a at the front ends engage with the respective engagement holes 6. Accordingly, the cover 3 is surely attached to the case main body 2 and covers the opening 2a (see FIG. 1) of the case main body 2 from above, and detachment (separation) of the cover 3 from the case main body 2 is surely prevented.

As described above, the cover 3 is easily and surely attached to the case main body with one-touch action by being simply pushed down while the engagement claws are aligned with the respective engagement holes of the case main body, and detachment (separation) of the cover 3 from the case main body is surely prevented.

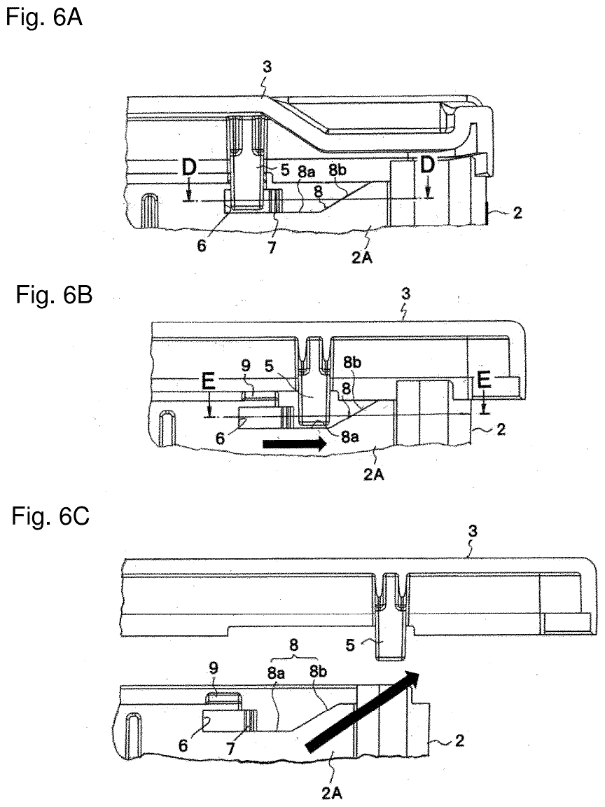

Next, a method of detaching the cover 3 attached to the case main body 2 by the above-described method, from the case main body 2 is described with reference to FIGS. 6A to 6C to FIG. 8.

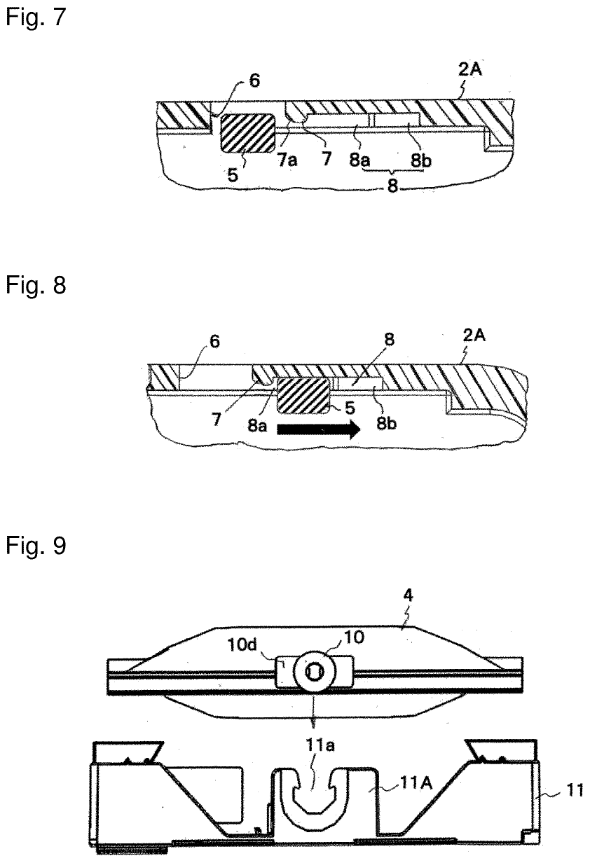

FIGS. 6A to 6C are partial side views illustrating the method of detaching the cover in a step order (diagrams of case main body as viewed from inside). FIG. 7 is a cross-sectional view taken along line D-D in FIG. 6A. FIG. 8 is a cross-sectional view taken along line E-E in FIG. 6B.

To detach the cover 3 from the case main body 2 in the state where the engagement claws 5 of the cover 3 engage with the respective engagement holes 6 of the case main body 2 and detachment of the cover 3 from the case main body 2 is inhibited (see FIG. 6A and FIG. 7), the cover 3 is horizontally slid rearward (in illustrated arrow direction) as illustrated in FIG. 6B and FIG. 8. As a result, the claw portions 5a of the engagement claws 5 of the cover 3 engage with the respective tapered surfaces 7a of the guide protrusions 7. Thus, the engagement claws 5 are deflected to the inside of the case main body 2 (front side in FIG. 6B), and are allowed to pass through the respective guide protrusions 7 of the cover 3. Therefore, as illustrated in FIG. 6B and FIG. 8, the engagement claws 5 of the cover 3 and the engagement holes 6 of the case main body 2 disengage from each other.

When the cover 3 is further slid rearward (in arrow direction in FIG. 6B) from the above-described state, the engagement claws 5 of the cover 3 are slid along the respective slide portions 8. While the engagement claws 5 of the cover 3 are slid on the straight surfaces 8a of the slide portions 8, the cover 3 maintains the state covering the case main body 2. When the engagement claws 5 are slid in an arrow direction in FIG. 6C along the respective inclined surfaces 8b of the slide portions 8, the cover 3 floats from the case main body 2, and a gap gradually increased is generated therebetween. In the above-described manner, when the cover 3 floats from the case main body 2 and the predetermined gap is formed therebetween from the state where the engagement claws 5 of the cover 3 and the engagement holes 6 of the case main body 2 disengage from each other, the user can insert a hand into the gap, lift up the cover 3, and easily detach the cover 3 from the case main body 2 with high workability.

As described above, in the ink cartridge 1 according to the present example embodiment, the cover 3 can be surely attached to the case main body 2, and the cover 3 can be easily detached from the case main body 2.

Next, a structure to mount the ink bag 4 on the ink cartridge 1 according to the present example embodiment, in particular, a structure to mount an ink supply connector 10 of the ink bag 4 on an adapter 11 of the case main body 2 is described below with reference to FIG. 9 to FIG. 13.

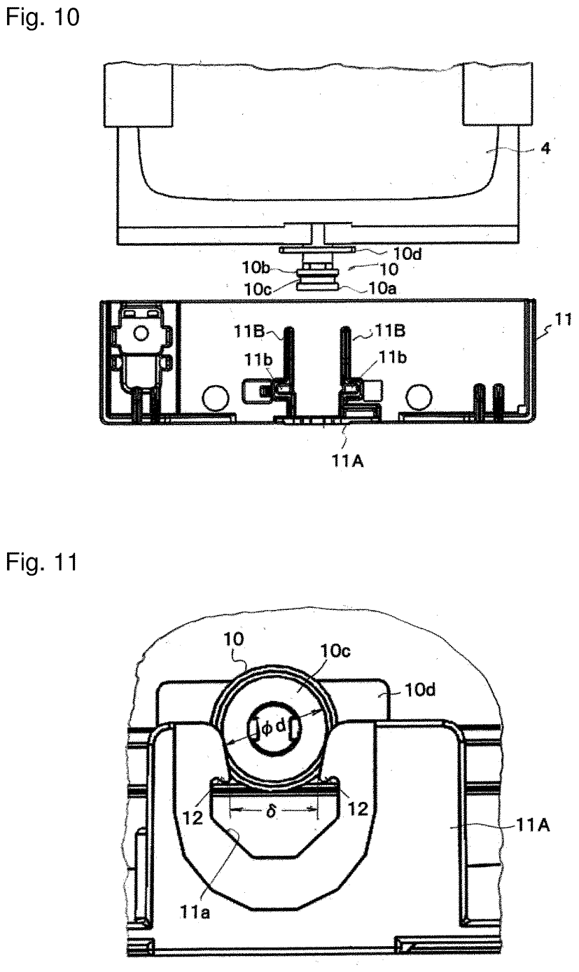

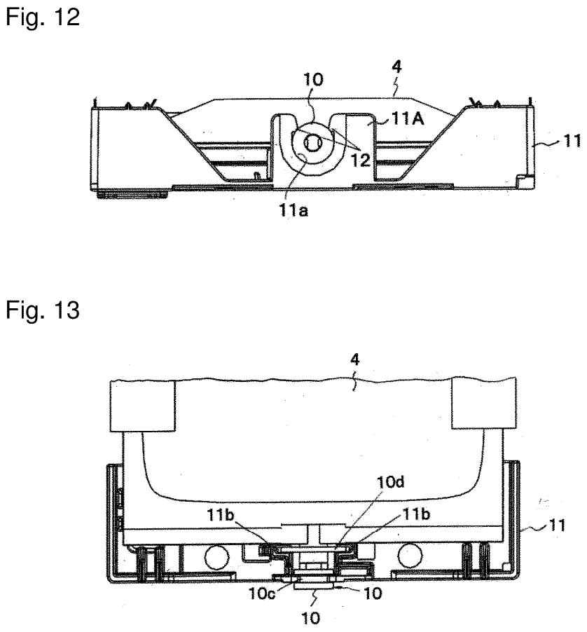

FIG. 9 is a front view illustrating a state before the ink bag is mounted. FIG. 10 is a partial plan view illustrating the same state. FIG. 11 is a partial front view illustrating a state where the ink bag is mounted. FIG. 12 is a front view illustrating a state after the ink bag is mounted. FIG. 13 is a partial front view illustrating the same state.

The ink supply connector 10 made of a resin is attached to a width-direction center portion at one end of the ink bag 4 in a longitudinal direction. Ink inside the ink bag 4 is supplied to an unillustrated recording head of the inkjet printer through an unillustrated tube connected to the ink supply connector 10. As illustrated in FIG. 10, the ink supply connector 10 includes, at a front end portion, two flange portions 10a and 10b that are integrally provided and are separated in an axis direction (up-down direction in FIG. 10). A cylindrical fitting portion 10c having an outer diameter ød smaller than an outer diameter of each of the flange portions 10a and 10b is integrally provided between the flange portions 10a and 10b. Further, a rectangular or substantially rectangular coupling plate 10d is integrally provided at a connection portion (base end portion) of the ink supply connector 10 with the ink bag 4.

On the other hand, the adapter 11 that is made of a resin and is separate from the case main body 2 is provided on the case main body 2. As illustrated in FIG. 9, a fitting plate 11A perpendicularly stands at a width-direction (right-left direction) center at a front end (lower end in FIG. 10) of the adapter 10. A U-shaped fitting groove 11a including an upper opening in a front view is provided along the up-down direction in the fitting plate 11A. Further, as illustrated in FIG. 10, a pair of right and left guide walls 11B integrally extend from a rear side of the fitting plate 11A (upper part in FIG. 10). Concave fitting grooves 11b to which the coupling plate 10d of the ink supply connector 10 is fitted are provided to face each other at intermediate portions of the respective guide walls 11B in the front-rear direction.

In the present example embodiment, as illustrated in FIG. 11, a pair of stopper protrusions 12 each including a claw shape are integrally provided on an inner surface on an opening side of the fitting groove 11a provided in the fitting plate 11A of the adapter 11. The pair of stopper protrusions 12 face each other with a gap δ (<ϕd) smaller than the outer diameter od of the fitting portion 10c of the ink supply connector 10.

The ink bag 4 is mounted by fitting the ink supply connector 10 of the ink bag 4 to the fitting groove 11a provided in the fitting plate 11A of the adapter 11 from above. More specifically, when the fitting portion 10c of the ink supply connector 10 is fitted to the fitting groove 11a of the adapter 11 from above, the fitting portion 10c passes through the gap δ between the stopper protrusions 12 provided on the inner surface of the fitting groove 11a of the adapter 11 while deflecting the stopper protrusions 12 to expand the gap δ therebetween as illustrated in FIG. 11 because the outer diameter ϕd of the fitting portion 10c is greater than the gap δ between the stopper protrusions 12 (δ<ϕd). Thereafter, the fitting portion 10c is fitted to the fitting groove 11a of the adapter 11 as illustrated in FIG. 12 and FIG. 13.

As described above, in the state where the fitting portion 10c of the ink supply connector 10 is fitted to the fitting groove 11a of the adapter 11, detachment of the ink supply connector 10 from the fitting groove 11a is surely prevented by the pair of stopper protrusions 12 provided on the inner surface of the fitting groove 11a because the gap δ between the pair of stopper protrusions 12 is smaller than the outer diameter ϕd of the fitting portion 10c of the ink supply connector 10 (δ<ϕd). At this time, as illustrated in FIG. 13, the coupling plate 10d of the ink supply connector 10 is fitted to the fitting grooves 11b provided in the pair of guide walls 11B of the adapter 11, and the ink supply connector 10 is surely positioned with respect to the adapter 11.

As described above, by the structure to mount the ink supply connector 10 on the adapter 11 according to the present example embodiment, it is possible to accurately position and surely fit the ink supply connector 10 of the ink bag 4 to the adapter 11 of the case main body 2, to surely prevent detachment of the ink supply connector 10 from the adapter 11, and to enable the user to clearly recognize completion of fitting of the ink supply connector 10 to the adapter 11.

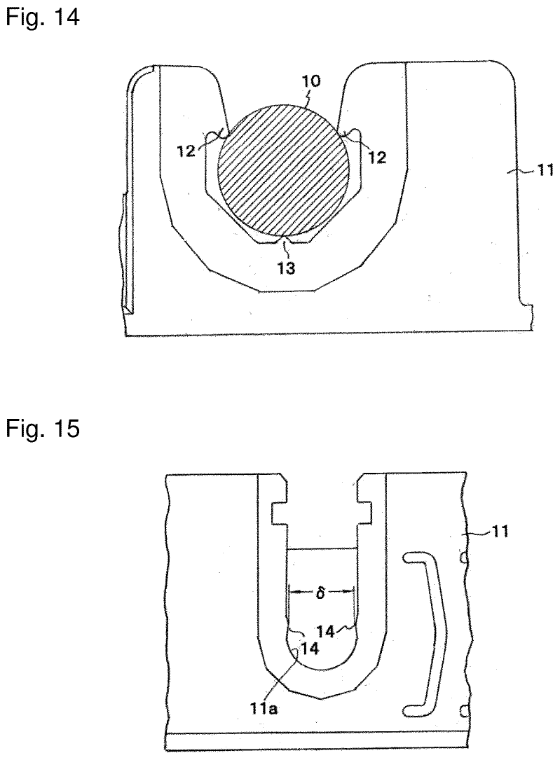

As illustrated in FIG. 14, a supporting protrusion 13 including a claw shape may be provided on a bottom portion of the fitting groove 11a provided in the adapter 11, and the ink supply connector 10 may be supported at three points by two stopper protrusions 12 and one supporting protrusion 13. When the ink supply connector 10 is supported at the three points as described above, the ink supply connector 10 can be more accurately positioned with respect to the adapter 11.

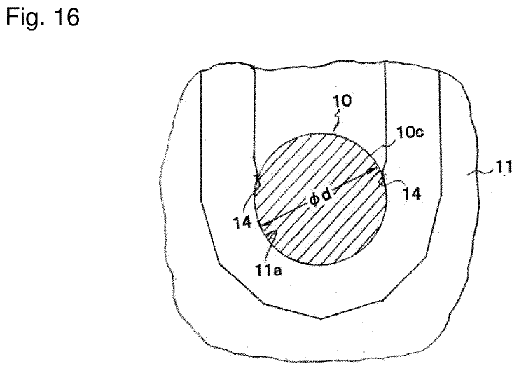

Further, as illustrated in FIG. 15, a pair of mountain-shaped stopper protrusions 14 facing each other may be integrally provided on portions of the inner surface of the fitting groove 11a of the adapter 11. In this example, in a state before the ink supply connector 10 is fitted to the fitting groove 11a, a gap (initial gap) δ between the pair of stopper protrusions 14 is set smaller than the outer diameter ϕd (see FIG. 16) of the fitting portion 10c of the ink supply connector 10 (δ<ϕd).

Therefore, when the fitting portion 10c of the ink supply connector 10 is fitted to the fitting groove 11a of the adapter 11 from above, the fitting portion 10c passes through the gap between the pair of stopper protrusions 14 provided on the inner surface of the fitting groove 11a while pushing and expanding the gap between the pair of stopper protrusions 14, and is surely fitted to the fitting groove 11a as illustrated in FIG. 16. At this time, the fitting portion 10c of the ink supply connector 10 is pressed by the pair of stopper protrusions 14, predetermined frictional resistance force acts on pressed portions, and detachment of the ink supply connector 10 from the fitting groove 11a is surely prevented by the frictional resistance force.

In addition, the guide protrusions 7 are provided along the edges of the engagement holes 6, and the guide protrusions 7 include the tapered surfaces 7a deflecting the engagement claws 5 in the direction in which the engagement claws 5 disengage from the respective engagement holes 6 during detachment of the cover 3. Therefore, the cover 3 can be easily detached from the case main body 2 with high workability.

The slide portions 8 include the straight surfaces 8a linearly extending along the case main body 2 between the engagement holes 6 and the inclined surfaces 8b. Therefore, the cover 3 can be easily detached from the case main body 2 with high workability.

The mounting structure in which the ink supply connector 10 of the ink bag 4 is fitted to the U-shaped fitting groove 11a of the case main body 2 to fix the ink supply connector 10 to the case main body 2 is provided, and the pair of stopper protrusions facing each other with the gap smaller than the outer diameter of the fitting portion of the ink supply connector 10 are provided on the inner surface of the fitting groove 11a. Therefore, it is possible to accurately position and surely fit the ink supply connector 10 of the ink bag 4 to the fitting groove 11a of the case main body 2, to surely prevent detachment of the ink supply connector 10 from the case main body 2 by the stopper protrusions, and to enable the user to clearly recognize completion of fitting of the ink supply connector 10 to the adapter 11.

In addition, the mounting structure is provided on the adapter 11 of the case main body 2 and fixes the ink supply connector 10 to the case main body 2. Therefore, it is possible to accurately position and surely fit the ink supply connector 10 of the ink bag 4 to the adapter 11, to surely prevent detachment of the ink supply connector 10 from the adapter 11, and to enable the user to clearly recognize completion of fitting of the ink supply connector 10 to the adapter 11.

In addition, since the protrusion 13 supporting the fitting portion 10c of the ink supply connector 10 is provided on the bottom portion of the fitting groove 11a, it is possible to further accurately position the ink supply connector 10 to the adapter 11.

It is apparent that the applicability of the present invention is not limited to the above-described example embodiment, and various modifications can be made within the scope of the technical ideas recited in the claims, the specification, and the drawings. For example, in the present example embodiment, the engagement claws are provided on the cover, and the engagement holes are provided in the case main body. However, the engagement holes may be provided in the cover, and the engagement claws may be provided on the case main body. In addition, any of the main body side walls and the cover side walls may be provided on the inside or the outside. Further, box shapes having the side walls substantially equal in length to each other may be superimposed and used as the cartridge. The shape is not limited to the rectangular or substantially rectangular shape as long as the side walls facing each other and parallel or substantially parallel to each other are provided, and the case main body and the cover can be slid to each other.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ink cartridge comprising:
a box-shaped case main body including side walls facing each other and an opening;
a cover attachably/detachably covering the opening of the case main body and including cover side walls superimposed on main body side walls of the case main body in a mounted state;
a replaceable ink bag housed in a space defined by the case main body and the cover;
one or more engagement claws on one of the cover side walls and the main body side walls, and protruding toward the other of the main body side walls and the cover side walls facing in the mounted state;
one or more engagement holes on the other of the main body side walls and the cover side walls and engageable with the one or more engagement claws; and
slide portions including, near the engagement holes, inclined surfaces extending toward ends of the main body side walls or the cover side walls from the engagement holes to slide and guide the engagement claws when the case main body and the cover are detached from each other.

2. The ink cartridge according to claim 1, further comprising:
guide protrusions along edges of the respective engagement holes; wherein
the guide protrusions include tapered surfaces to deflect the engagement claws in a direction in which the engagement claws disengage from the respective engagement holes during detachment of the cover.

3. The ink cartridge according to claim 1, wherein the slide portions include straight surfaces linearly extending along the case main body, between the engagement holes and the inclined surfaces.

4. The ink cartridge according to claim 1, further comprising a mounting structure in which an ink supply connector of the ink bag is fitted to a U-shaped or substantially U-shaped fitting groove of the case main body to fix the ink supply connector to the case main body; wherein
a pair of stopper protrusions facing each other with a gap smaller than an outer diameter of a fitting portion of the ink supply connector are provided on an inner surface of the fitting groove.

5. The ink cartridge according to claim 4, wherein the mounting structure is provided on an adapter of the case main body and fixes the ink supply connector to the case main body.

6. The ink cartridge according to claim 4, wherein a supporting protrusion to support the fitting portion of the ink supply connector is provided on a bottom portion of the fitting groove.
